(19) United States
(12) Patent Application Publication
(10) Pub. No.: US 2026/0001376 A1
(43) Pub. Date: Jan. 1, 2026

(54) WIRELESSLY POWERED SENSOR SYSTEM

(71) Applicant: Truck-Lite Co., LLC, Falconer, NY (US)

(72) Inventors: Mike Marley, Pittsburgh, PA (US); Justin Gregory, Pittsburgh, PA (US); Paul Sniegocki, Pittsburgh, PA (US); Roger Elmer, Pittsburgh, PA (US)

(21) Appl. No.: 19/251,484

(22) Filed: Jun. 26, 2025

Related U.S. Application Data
(60) Provisional application No. 63/664,419, filed on Jun. 26, 2024.

(51) Int. Cl. B60C 23/04; H02J 50/23; H02J 50/80

(52) U.S. Cl. CPC B60C 23/0413; H02J 50/23; H02J 50/80

(57) ABSTRACT

A wirelessly powered sensor system includes a wireless receiver that monitors tire pressure and is capable of broadcasting a short-range radio frequency (RF) signal indicating low tire pressure configured to be received at a vehicle; a rechargeable battery electrically coupled to the wireless receiver; and an RF to direct current (DC) power converter electrically coupled to the rechargeable battery and configured to receive RF power wirelessly supplied by a wireless power transmitter.

### PRIORITY CLAIM

The present application claims priority to Provisional Application No. 63/664,419 filed Jun. 26, 2024 the entire contents of which are incorporated by reference.

### FIELD OF INVENTION

The present invention relates to a wirelessly powered sensor system, specifically for trailer sensors and tire pressure monitoring sensors on a trailer or vehicle.

### BACKGROUND

Tire pressure monitoring systems (TPMS) commonly integrate a pressure transducer, transmitter, and antenna, all mounted to the tire stem of trailers. Upon detecting a tire pressure below a preselected threshold, the pressure transducer triggers the transmitter to broadcast a radio frequency (RF) signal. This signal is detected by a receiver mounted on the vehicle, alerting the driver of the low tire pressure condition to prevent potential blowouts. TPMS is currently battery-operated, and the batteries must be replaced periodically to ensure the system's proper operation. In alternate embodiments, TPMS systems may be hard wired with power, however failed electrical connections at the sensor contribute to numerous failures. Hard wired electrical connections are additionally difficult to configure given the remote locations of the tires on a trailer vehicle.

Accordingly, an improved system for providing power to remotely located sensors on a vehicle is needed.

### SUMMARY

In one aspect of the disclosure, a wirelessly powered sensor system includes a wireless receiver that monitors tire pressure and is capable of broadcasting a short-range radio frequency (RF) signal indicating low tire pressure configured to be received at a vehicle; a rechargeable battery electrically coupled to the wireless receiver; and an RF to direct current (DC) power converter electrically coupled to the rechargeable battery and configured to receive RF power wirelessly supplied by a wireless power transmitter.

In another aspect of the disclosure, a wirelessly powered sensor system, includes a wireless power transmitter configured to wirelessly supply radio frequency (RF) power; a wireless receiver that monitors tire pressure and is capable of broadcasting a short-range RF signal indicating low tire pressure configured to be received at a vehicle; a rechargeable battery electrically coupled to the wireless receiver; and an RF to direct current (DC) power converter electrically coupled to the rechargeable battery and configured to receive RF power wirelessly supplied by a wireless power transmitter.

### BRIEF DESCRIPTION OF THE DRAWINGS

The operation of the invention may be better understood by reference to the detailed description taken in connection with the following illustrations, wherein:

FIG. 1 illustrates a top perspective view of a wirelessly powered TPMS on a trailer vehicle;

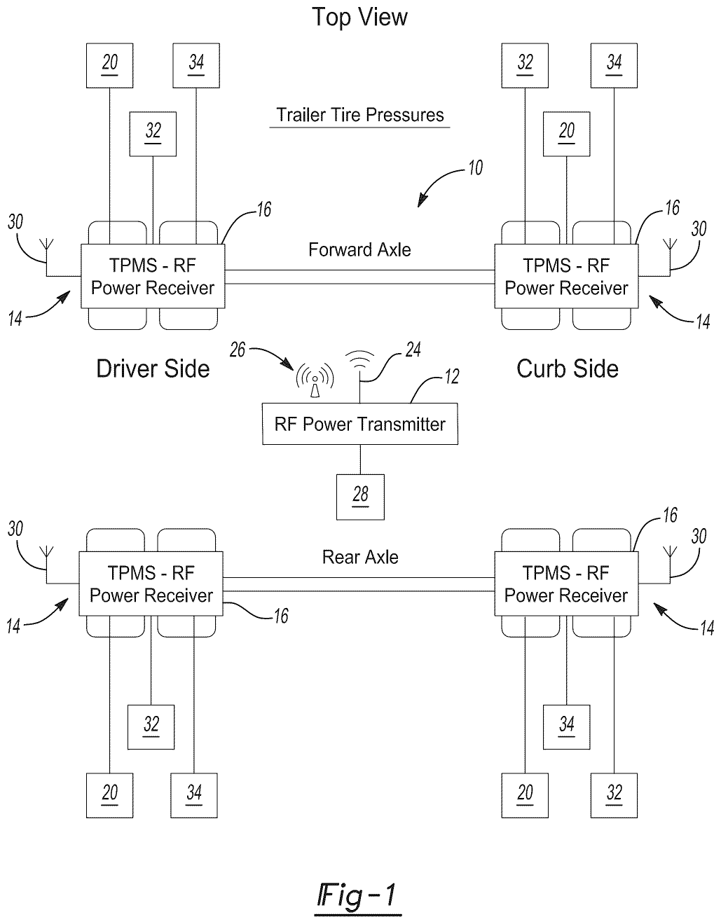

FIG. 2 illustrates a rear perspective view of a wirelessly powered TPMS on a trailer vehicle;

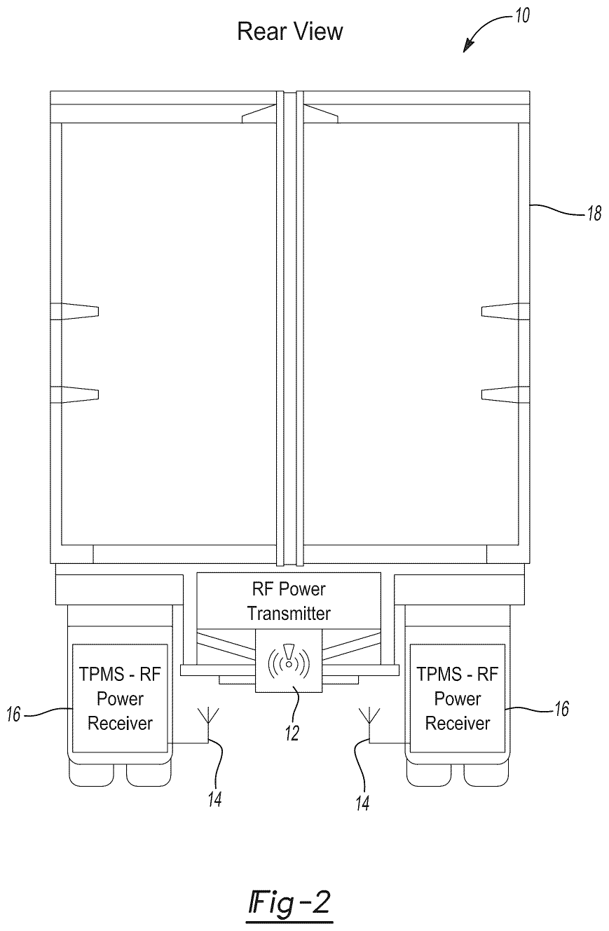

### DETAILED DESCRIPTION

Reference will now be made in detail to exemplary embodiments of the present invention, examples of which are illustrated in the accompanying drawings. It is to be understood that other embodiments may be used and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

A wirelessly powered sensor system 10 is generally presented. The wirelessly powered sensor system 10 includes a wireless power transmitter 12 and one or more wireless power receiver modules 14. The wireless power transmitter 12 and receivers 14 may be configured to send and receive RF power.

The wireless receivers 14 may be configured to replace the disposable batteries or hardwired connection of a traditional TPMS and allow sensors to receive wireless power. The wireless receivers 14 can include an antenna 30, a voltage indicator 32, an RF-to-Direct Current (DC) power converter 34, and a rechargeable battery 20. The wireless receiver 14 can monitor the voltage of the rechargeable battery 20 in the wirelessly powered sensor system 10. When the rechargeable battery 20 is under optimal charging levels, the wireless receiver 14 can communicate with the wireless transmitter 12, such as by sending a wireless message via RF to the wireless transmitter 12, and, in response to receiving that wireless signal at the wireless transmitter 12, the wireless power transmitter 12 can start transmitting wireless power from the wireless power transmitter 12 to the wireless receiver 14. The wireless receiver 14 can convert the wireless RF power to a DC voltage and use the DC voltage to charge the rechargeable battery 20. Once the rechargeable battery 20 is charged, the wireless receiver 14 can indicate to the wireless power transmitter 12 to stop supplying the wireless receiver 14 RF power.

The wireless power transmitter 12 can include an antenna 24 for RF power transmission, a data transmission antenna 26 for data transmission and an energy storage device 28. The energy storage device 28 can be charged from a vehicle battery, such as a battery carried by a semi-truck, or solar power. The wireless power transmitter 12 may be powered by a vehicle (not shown) or by a trailer 18 towed by the vehicle, such as a semi-truck, and the wireless power transmitter 12 may use this power to transmit data about the any aspect of the status of the wireless powered system 10 (state of charge, pressure levels). The wireless power transmitter 12 can also begin transmitting RF power to the wireless receiver 14 after receiving a wireless message from the wireless receiver 14 indicating that the battery indicator at the wireless receiver 14 indicates the rechargeable battery 20 has fallen below a low charge threshold.

The wirelessly powered sensor system may obviate the need for battery replacement thus reducing labor costs and trailers downtime due to battery replacements.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

1. A wirelessly powered sensor system, comprising:
a wireless receiver that monitors tire pressure and is capable of broadcasting a short-range radio frequency (RF) signal indicating low tire pressure configured to be received at a vehicle;
a rechargeable battery electrically coupled to the wireless receiver; and
an RF to direct current (DC) power converter included with the wireless receiver and electrically coupled to the rechargeable battery and configured to receive RF power wirelessly supplied by a wireless power transmitter.

2. The wirelessly powered sensor system recited in claim 1, further comprising a voltage indicator carried by the at least one wireless receiver that monitors the rechargeable battery to determine whether a charge state has fallen below a low voltage threshold and, if so, wirelessly transmitting a message to the wireless power transmitter to begin transmitting wireless power.

3. The wirelessly powered sensor system recited in claim 1, wherein the voltage indicator monitors the rechargeable battery while the wireless power transmitter transmits wireless power to determine if the charge state of the rechargeable battery has risen above the low voltage threshold.

4. A wirelessly powered sensor system, comprising:
a wireless power transmitter configured to wirelessly supply radio frequency (RF) power;
a wireless receiver that monitors tire pressure and is capable of broadcasting a short-range RF signal indicating low tire pressure configured to be received at a vehicle;
a rechargeable battery electrically coupled to the wireless receiver; and
an RF to direct current (DC) power converter electrically coupled to the rechargeable battery and configured to receive RF power wirelessly supplied by a wireless power transmitter.

5. The wirelessly powered sensor system recited in claim 4, further comprising a voltage indicator carried by the at least one wireless receiver that monitors the rechargeable battery to determine whether a charge state has fallen below a low voltage threshold and, if so, wirelessly transmitting a message to the wireless power transmitter to begin transmitting wireless power.

6. The wirelessly powered sensor system recited in claim 4, wherein the voltage indicator monitors the rechargeable battery while the wireless power transmitter transmits wireless power to determine if the charge state of the rechargeable battery has risen above the low voltage threshold.

7. The wirelessly powered sensor system recited in claim 4, wherein the wireless power transmitter further comprises an antenna for RF power transmissions.

8. The wirelessly powered sensor system recited in claim 4, wherein the wireless power transmitter further comprises a data transmission antenna.

9. The wirelessly powered sensor system recited in claim 4, wherein the wireless power transmitter further comprises and energy storage device.

10. The wirelessly powered sensor system recited in claim 4, wherein the wireless power transmitter receives electrical power from a trailer.
